(19) United States
(12) Patent Application Publication
(10) Pub. No.: US 2016/0130189 A1
(43) Pub. Date: May 12, 2016

(54) A PRODUCT FOR COATING FERTILIZERS

(71) Applicant: Sundaresan SUBRAMANYAM, Chennai (IN)

(72) Inventor: Sundaresan SUBRAMANYAM, Chennai (IN)

(21) Appl. No.: 14/896,486

(22) PCT Filed: May 12, 2014
(86) PCT No.: PCT/IN2014/000325

§ 371 Date: Dec. 7, 2015

(30) Foreign Application Priority Data
Jun. 7, 2013 (IN) 2507/CHE/2013

(51) Int. Cl. C05B 17/00; C05G 3/00

(52) U.S. Cl. CPC C05B 17/00; C05G 3/0029; C05G 3/0041

(57) ABSTRACT

The present invention relates to a product for coating fertilizer in “place of use”, i.e. in the field at the time of application. The product comprises of two or more of the following constituents: facilitator; neutral acid slurry; bentonite clay and resin. The product is mixed in place of use with conventional fertilizer. The facilitator is a starter Heterocyclic compound comprising of Heterocyclic Nitrogen (N-18%) in amounts of 187 gm to 375 gm with Phosphorus (P-6%) and Potassium (K-9%) per acre. Advantageously, the product for coating fertilizer prevents runoff seepage, wastage, dead zones in sea/water bodies, saves fertilizer usage and allows plants to consume raw materials.

### FIELD OF INVENTION

The present invention relates to a product for coating fertilizer. More specifically, the present invention relates to a product for coating fertilizers in “place of use”, i.e. in the field at the time of application. The product contains economical compounds that are easy to use and selected from nature. Further, the present invention relates to a method of preparation of the product. Advantageously, the product for coating fertilizer prevents runoff, seepage, wastage, dead zones in sea/water bodies, saves fertilizer usage and allows plants to consume raw materials.

### DESCRIPTION OF PRIOR ART

Fertilizers are essential for plants as they provide nutrients essential for the growth of plants. The fertilizers used may either be solid fertilizers in granular or powder form or liquid fertilizers. The use of commercially available inorganic fertilizers has increased greatly. However, excessive use of fertilizer has resulted in negative environmental effects. Considerable proportion of applied fertilizer is lost during the year of application and this is aggravated in sandy, laterite and light soils. Moreover, excessive use of fertilizers has resulted in nitrogen pollution. Excess nitrogen pollution invites pests, virus, mycoplasma etc. Pollution of water bodies by nitrogen harms marine ecosystems and contributes to global warming Fertilizer runoff has created four hundred dead zones in oceans and this is likely to spread every two years.

Soluble fertilizers are coated or encapsulated in membranes to control the rate of nutrient release, which has environmental, economic, and plant/crop yield benefits. Slow nutrient release provides nutrition to plants uniformly thereby improving plant performance. However, the nutrient release from coated fertilizers is dependent on a number of environmental factors such as soil temperature, moisture and soil microbial activity. The entire world is harping upon slow release and it rests with lawn only; even otherwise, the move is not accepted because of coating product, which has become anathema for most countries.

Various coating methods are known in prior art to coat granule or pellet fertilizers. Some of the prior arts are:
U.S.20100011825 discloses a fertilizer coating using elemental sulfur which involved spraying molten sulfur over urea granules, followed by application of wax to remove any cracks, if present on the coating.
IN194469 relates to a coated granular fertilizer obtained by producing in situ on surface of granules a coating comprising one or more ammonium, magnesium, phosphate or potassium compounds.
U.S. Pat. No. 6,254,655 relates to granular composite fertilizer compositions prepared by applying a liquid mixture of urea and formaldehyde to a dry substrate such as a phosphorus source, a potassium source, a secondary nutrient source, a micronutrient source or mixtures thereof and reacting the liquid mixture in situ to form methylene urea reaction products.

Also known in prior art is coating fertilizers on the surface using organic polymers. In addition, factory coating of fertilizers with Boron, Zinc etc is not appreciated because of costs involved and also the unbalanced nutrients serves no purpose i.e. to prevent fertilizer run off.

Organic fertilizers are also being used as they are more environment-friendly although they contain lower concentration of plant nutrients. However, in temperate countries undigested compost has created ecological problems e.g. E. coli problem. Additionally, conventional fertilizers are not heterocyclic.

Accordingly, there exists a need for a product and method for coating fertilizers in “place of use”, which is less expensive, easy to use and environment-friendly.

### OBJECTS OF INVENTION

The primary object of the present invention is to provide a product for coating fertilizer or a coating agent.

It is another object of the present invention to provide a product for coating fertilizers in “place of use”, i.e. in the field at the time of application.

It is another object of the present invention to provide a method of preparation of the product.

It is another object of the present invention, wherein the product contains economical compounds that are easy to use and selected from nature.

It is another object of the present invention, wherein the product prevents runoff, seepage, wastage, dead zones in sea/water bodies, saves fertilizer usage and allows plants to consume raw materials.

In one aspect of the present invention, wherein the product for coating fertilizer comprises of facilitator (catalyst) and neutral acid slurry, the said product is mixed with conventional/regular fertilizer.

It is another object of the present invention, wherein the facilitator (catalyst) is heterocyclic nitrogen (N-18%) in amounts of 187 gm to 375 gm with phosphorus (P-6%) and potassium (K-9%) per acre.

It is another object of the present invention, wherein the facilitator gives starting heterocyclic compound and is prepared freshly for each mixing with conventional/regular fertilizers.

It is another object of the present invention, wherein the product is prepared by mixing constituents as shown below to coat fertilizer for one acre (approximately 50-100 kg of fertilizers):
(i) 1 kg of facilitator+250 gm of acid slurry; or
(ii) 2 kg of facilitator+500 gm of acid slurry.

In another aspect of the invention, the product for coating fertilizer comprises of:
facilitator;
bentonite clay (nature clay); and
resin.

It is another object of the present invention, wherein the product is prepared by mixing constituents as shown below to coat fertilizer for one acre (approximately 50-100 kg of fertilizers):
(i) 1 kg of facilitator+1 kg of Bentonite clay+250 gm of Resin; or
(ii) 1 kg of facilitator+1 kg of Bentonite clay+500 gm of Resin.

### SUMMARY OF INVENTION

Thus according to the basic aspect of present invention there is provided a product to coat fertilizer in place of use, said product comprising two or more of following constituents:
Facilitator;
Neutral acid slurry;
Bentonite clay; and
Resin,
wherein the product is mixed in place of use with conventional fertilizer.

Another aspect of the present invention is to provide a product to coat fertilizer utilized for one acre comprising of:
Facilitator: 1000 gm; and
Neutral acid slurry: 250 gm.

Yet another aspect of the present invention is to provide a product to coat fertilizer utilized for one acre comprising of:
(i) 1000 gm of facilitator; 1000 gm of Bentonite clay; and 250 gm of Resin; or
(ii) 1000 gm of facilitator; 1000 gm of Bentonite clay; and 500 gm of Resin,
wherein the resin is preferably vegetable oil resin.

It is another aspect of the present invention, wherein the facilitator is a starter Heterocyclic compound comprising of Heterocyclic Nitrogen (N-18%) in amounts of 187 gm to 375 gm with Phosphorus (P-6%) and Potassium (K-9%) per acre.

Another aspect of the present invention is to provide a method of preparing the facilitator comprising the steps of:
Mixing Melamine (C3H6N6), HEDP (C2H8P2O7) and water thoroughly in a reaction tank to get homogenous slurry after heating at 50° C.;
Adding Potassium Hydroxide (KOH) to the homogenous slurry and mixing thoroughly;
Allowing the resultant mixture obtained to dry at moderate temperature in a mechanical. drier;
Optionally, sieving to improve uniformity and remove dirt; and
Obtaining final product comprising Melamine Phosphate and Potash complex as a facilitator and starter

A further aspect of the present invention is to provide a method of preparing the neutral acid slurry comprising the steps of:
Adding Sodium Hydroxide (NaOH) to acid Alkyl Benzene Sulfonate in a stainless steel vessel or heat resistant plastic vessel and mixing slowly till neutral pH is obtained; and
Obtaining black colored resultant slurry and further bleaching with urea in the ratio 1:10 kg slurry to obtain the neutral acid slurry.

### BRIEF DESCRIPTION OF THE DRAWINGS

FIG. 1 is a flow chart showing the method of preparation of the facilitator.

FIG. 2 is a flow chart showing the method of preparation of neutral acid slurry.

### DETAILED DESCRIPTION OF THE INVENTION WITH RESPECT TO ACCOMPANYING DRAWINGS

The present invention as herein described relates to a product for coating fertilizers in “place of use”. Further, the present invention relates to a method of preparation of the product. The product contains economical compounds that are easy to use and selected from nature. Advantageously, the product prevents runoff, seepage, wastage, dead zones in sea/water bodies, saves fertilizer usage and allows plants to consume raw materials.

The product for coating fertilizer comprises of facilitator (catalyst) and neutral acid slurry, the said product is mixed with conventional/regular fertilizer. The facilitator (catalyst) is heterocyclic nitrogen (N-18%) in amounts of 187 gm to 375 gm with phosphorus (P-6%) and potassium (K-9%) per acre. The facilitator gives starting heterocyclic compound and is prepared freshly for each mixing with conventional/regular fertilizers.

The product is prepared by mixing constituents as shown below to coat fertilizer for one acre (approximately 50-100 kg of fertilizers):
(i) 1 kg of facilitator+250 gm of acid slurry; or
(ii) 2 kg of facilitator+500 gm of acid slurry.

In another embodiment of the invention, the product for coating fertilizer comprises of:
facilitator;
bentonite clay (nature clay); and
resin.

The product is prepared by mixing constituents as shown below to coat fertilizer for one acre (approximately 50-100 kg of fertilizers):
(i) 1 kg of facilitator+1 kg of Bentonite clay+250 gm of Resin; or
(ii) 1 kg of facilitator+1 kg of Bentonite clay+500 gm of Resin.
The resin is preferably vegetable oil resin.

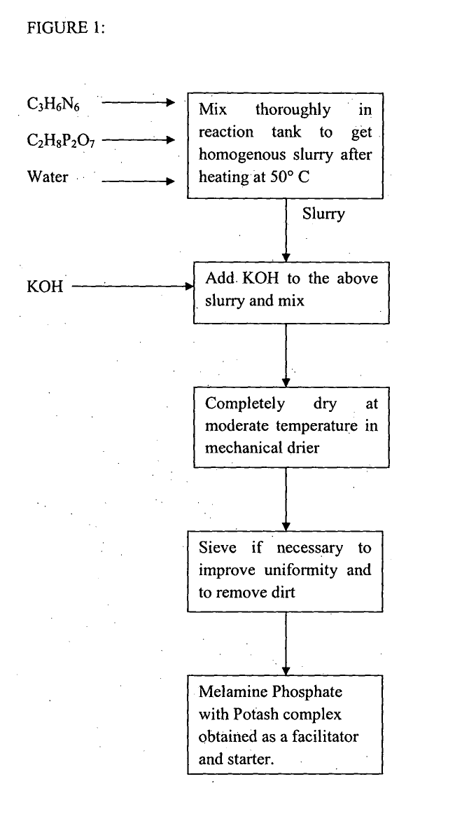

FIG. 1 is a flow chart illustrating a method of preparation of the facilitator; the said method comprises the steps of:
Mixing Melamine (C₃H₆N₆), HEDP (C₂H₈P₂O₇) and water thoroughly in a reaction tank to get homogenous slurry after heating at 50° C.;
Adding Potassium Hydroxide (KOH) to the homogenous slurry and mixing thoroughly;
Allowing the resultant mixture obtained in the above step to completely dry at moderate temperature in a mechanical drier;
Optionally, sieving to improve uniformity and remove dirt; and
Obtaining final product comprising Melamine Phosphate and Potash complex as a facilitator and starter.

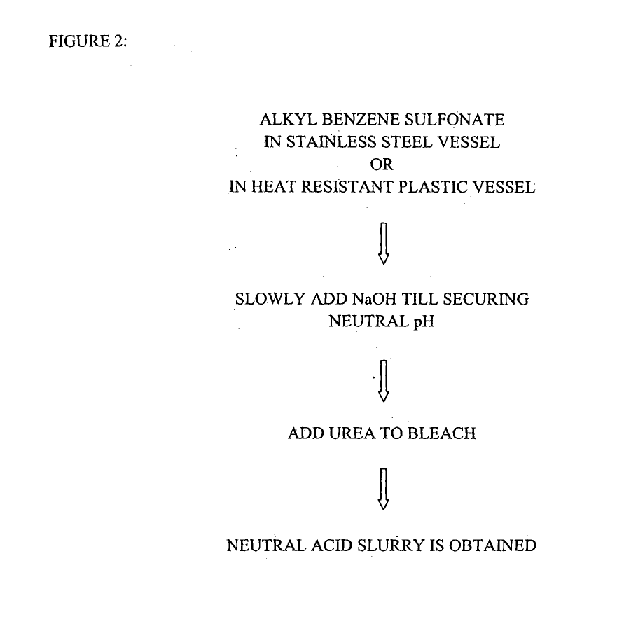

FIG. 2 is a flow chart illustrating a method of preparation of the neutral acid slurry the method comprises the steps of:
Taking required amount of acid Alkyl Benzene Sulfonate in a stainless steel vessel or heat resistant plastic vessel;
Adding Sodium Hydroxide (NaOH) to the Alkyl Benzene Sulfonate and mixing slowly [since heat generated is high] till neutral pH is obtained: and
Obtaining black colored resultant slurry and further bleaching with urea in the ratio 1:10 kg slurry to obtain neutral acid slurry.

The product is mixed in “place of use” with conventional fertilizers like Urea, Ammonium Sulphate, Diammonium Phosphate, Potassium Chloride etc in seed treating drum, barrels, buckets etc. Ideal is rotating seed treating drums, tractor application and even in aerial application. As the product is economical and can be easily applied in place of use, it is highly beneficial in least developed countries (LDC), under developed countries (UDC) and developing countries (DEV. C). In developed countries (Dev. C) also, where the fertilizer is applied through tractor, airplane etc, the product can be applied ‘in place of use’ and the cost is very minimum i.e approximately $3.75 per acre.

In liquid fertilizer application, a paraffin liquid mix of product at 1 to 2 kg/ acre of fertilizer is used. In developed countries, liquid fertilizers are fed to the plants through underground pipes from a built in tank containing the fertilizer. Liquid paraffin is mixed to the tanks hence providing a thick consistency to the fertilizers and preventing easy runoff. For liquid fertilizer application, 2 to 4 kg of acid slurry treated [soap oil] is used.

The addition of the facilitator gives the starting heterocyclic compound, which is essential for plants. The importance of heterocyclic compounds and fertilizers are:
Fertilizer reform.
Heterocyclic nitrogen and hetero compounds are loved by nature.
Heterocyclic nitrogen and hetero compounds enables plant to synthesize plant growth regulators (PGRs) and enzymes.
Heterocyclic nitrogen is capable of utilizing fertilizers efficiently and prevents run off and wastage.

Additionally the present invention helps save 25% fertilizer usage, thus saving subsidy, foreign exchange and helps over come the below disadvantages:
Fertilizer runoff creates dead zone in sea and water bodies.
Dead zones cause depletion of dissolved oxygen, which is a threat to marine life and causes global warming.
Dead zones chokes rivers, canals etc.

Table 1 shows the university result for fertilizer saving. It is a preliminary research. The present invention shows improved results.

TABLE 1
UNIVERSITY RESULTS FOR FERTILIZER SAVING

| | | |
|---|---|---|
| Punjab Agriculture | Cotton | 100% fertilizer and Allwin |
| University, Ludhiana. | | Top + 75% RDF yield |
| | | statistically on par. |
| Dr. Panjabarao Deshmukh | Cotton | 75% RDF + Allwin Top; |
| Krishi Vidyapeeth, Akola. | | Yield 11% increase. |
| Sugar cane Breeding | Sugar | In Clay soil - 75% RDF + |
| Institute, Coimbatore | cane | Allwin Wonder, 100% RDF; |
| [International Status]. | | Yield are equal. |
| | | In Sandy loam - 75% RDF |
| | | and Allwin Wonder; Yield |
| | | 3% increase. |
| Tamil Nadu Agriculture | Cardamom | 75% RDF; Yield 7% increase |
| University, Coimbatore. | | per clump. |

The present invention helps save environment, as minimum is lost and this helps maintain yield as much of the fertilizer finds its way into plants, which in turn provides food and array of materials to fauna.

Some of the remedial measures to prevent creation of dead zones in sea and water bodies are:
Using fewer fertilizers and adjusting timing of the fertilizer application to limit runoff of excess nutrients from farmland, also with coating agents in place of use.
Control of animal wastes so that they are not allowed to enter into waterways.
Monitoring of septic systems and sewage treatment facilities to reduce discharge of nutrients to surface water and ground water.
Careful industrial practices such as limiting discharge of nutrients, organic matter and chemicals from manufacturing facilities.
Mixing fertilizers with the coating product according to the present invention.

Various field experiments were conducted using the product of the present invention to study the effect on the growth, yield and quality of plants/crops.

### EXPERIMENT I

Field trials using the coating product were carried out on cardamom (Elettaria cardamomum Maton) at lower pulney hills in farmer's field for a period of one year. Table 2 shows the effect of ‘Allwin Top’ and ‘Allwin Wonder’ on number of capsules/spike. ‘Allwin Top’ and ‘Allwin Wonder’ are based on heterocyclic compound. On application of ‘Allwin Top’ and ‘Allwin Wonder’ on plants, the plants are able to synthesize vital plant growth regulators auxin, gibbrellin, and cytokynin and it helps plants to self generate defensive enzymes like phenyl ammonia lyases, tyrosine, ammonia lyase, peroxidase protease and chitinase.

‘Allwin Wonder’ contains the following constituents:

| | |
|---|---|
| i)Heterocyclic Nitrogen, minimum | 18% |
| ii)Water soluble phosphate, minimum (as P₂O₅) | 7.6% |
| iii)Water soluble potash, minimum (as K₂O) | 9% |
| iv)Humic acid | 45% |
| v)Moisture percent by weight, maximum | 1.5% |

The above said constituents are used at 1 to 2 Kg per acre as a facilitator and starter.

‘Allwin Top’ contains the following constituents:

| | |
|---|---|
| i)Heterocyclic Nitrogen, minimum | 27% |
| ii)Water soluble phosphate, minimum (as P₂O₅) | 11.2% |
| iii)Water soluble potash, minimum (as K₂O) | 7.36% |
| iv)Humic acid | 2% |
| v)Moisture percent by weight, maximum | 1.5% |

The above said constituents are used in foliar application for vigorous soil nutrients absorption thereby reducing runoff.

TABLE 2
EFFECT OF ‘ALLWIN TOP’ AND ‘ALLWIN WONDER’
ON NUMBER OF CAPSULES/SPIKE

| | Number of | Number of | Fresh yield |
|---|---|---|---|
| Treatment | capsules/panicle | capsules/plant | (g/plant) |
| T₁ | 9.80 | 1405.90 | 585.83 |
| T₂ | 10.83 | 1482.01 | 665.00 |
| T₃ | 11.42 | 1526.39 | 745.33 |
| T₄ | 9.46 | 1420.85 | 511.67 |
| T₅ | 8.52 | 1379.63 | 630.28 |
| T₆ | 11.96 | 1490.50 | 731.67 |
| T₇ | 12.67 | 1703.87 | 811.67 |
| T₈ | 7.61 | 1209.19 | 503.33 |
| SEd | 0.5915 | | |
| CD (0.05) | 1.2689 | | |
| CD (0.01) | 1.7610 | | |

[Cardamom heavy feeder and 25% reduction is extremely good and increase per clump is expected rise. This increase is huge from control.]

Among the several treatments, T₇ i.e. ‘Altwin Top’ as foliar spray 2 g/lit and ‘Allwin Wonder’ as soil application at 2.5 Kg/ha+75% RDF (recommended dose of fertilizer)+FYM (farm yard manure), exhibited more number of capsules per spike (12.67) and the treatments T₆ (11.96) and T₃ (11.42) were on par with the said trait. The lowest number of capsules per spike was registered in treatment T₈ (7.61) as seen from table 2.

The treatment T₇ i.e. ‘Allwin Top’ as foliar spray 2 g/lit+‘Allwin Wonder’ as soil application at 2.5 Kg/ha+75% RDF+FYM (farm yard manure), registered more number of capsules per plant (1703.87) which was followed by the treatment T₃ i.e. ‘Allwin top’ as foliar spray at 2 g/lit+75% RDF+FYM (farm yard manure) (1526.39). The lowest value was recorded in the treatment T₈ (No RDF+FYM−control) (1209.19).

The fresh yield was more in the treatment T₇ i.e. ‘Allwin Top’ as foliar spray 2 g/lit and ‘Allwin Wonder’ as soil application at 2.5 Kg/ha+75% RDF+FYM (811.67 g/plant) which was followed by the treatment T₃ i.e. ‘Allwin top’ as foliar spray at 2 g/lit+75% RDF+FYM (745.33 g/plant). The treatment T₈ (No RDF+FYM−control) recorded the lowest value (503.33 g/plant).

Table 3 shows the effect of ‘Allwin Top’ and ‘Allwin Wonder’ on fresh yield (g/plant) of cardamom.

TABLE 3
EFFECT OF ‘ALLWIN TOP’ AND ‘ALLWIN WONDER’
ON FRESH YIELD (G/PLANT)

| | Fresh yield |
|---|---|
| Treatment | (g/plant) |
| T₁ | 640.68 |
| T₂ | 725.52 |
| T₃ | 803.11 |
| T₄ | 593.00 |
| T₅ | 612.46 |
| T₆ | 788.33 |
| T₇ | 845.71 |
| T₈ | 511.65 |

From the above result, it is noted that the fresh yield was more in the treatment T₇ i.e. ‘Allwin Top’ as foliar spray 2 g/lit and ‘Allwin Wonder’ as soil application at 2.5 Kg/ha+75% RDF+FYM (farm yard manure) (845.71 g/plant) which was followed by the treatment T₃ i.e. ‘Allwin top’ as foliar spray at 2 g/lit+75% RDF+FYM (803.11 g/plant). The treatment T₈ (No RDF+FYM−control) recorded the lowest value (511.65 g/plant) as shown in table 3.

### EXPERIMENT II

A trial on evaluation of ‘Allwin Top’ as foliar spray and ‘Allwin Wonder’ as soil application on growth and green capsule yield performance of cardamom was conducted in a planter's field at Sembirankulam, during August 2010. The treatment details are as below.
1. ‘Allwin Top’ as foliar spray at 1 g/lit+RDF+FYM
2. ‘Allwin Top’ as foliar spray at 2 g/lit+RDF+FYM
3. ‘Allwin Top’ as foliar spray at 2 g/lit+75% RDF+FYM
4. ‘Allwin Wonder’ as soil application at 2.5 Kg/ha+100% RDF+FYM
5. ‘Allwin Wonder’ as soil application at 2.5 Kg/ha+75% RDF+FYM
6. ‘Allwin Top’ as foliar spray at 2 g/lit and ‘Allwin Wonder’ as soil application at 2.5 Kg/ha+100% RDF+FYM
7. ‘Allwin Top’ as foliar spray at 2 g/lit and ‘Allwin Wonder’ as soil application at 2.5 Kg/ha+75% RDF+FYM
8. Control (No RDF+FYM)

The recommended dose of fertilizer (RDF) used is heterocyclic nitrogen, P₂O₅ and K₂O (N:P₂O₅:K₂O) is in the ratio 75:75:150 Kg/ha and the farm yard manure (FYM) used is 5 kg/plant/year. The capsule yield of cardamom before the treatment application is furnished in table 4.

TABLE 4
YIELD PERFORMANCE OF GREEN CARDAMOM
(BEFORE TREATMENT APPLICATION)

| | Length of panicle | Number of | Number of |
|---|---|---|---|
| Treatments | (cm) | panicles/plant | capsules/plant |
| T₁ | 42.67 | 43.67 | 2195.67 |
| T₂ | 49.90 | 44.33 | 1062.33 |
| T₃ | 47.37 | 52.67 | 1518.00 |
| T₄ | 50.80 | 47.33 | 1357.67 |
| T₅ | 61.47 | 57.33 | 882.33 |
| T₆ | 50.27 | 44.67 | 639.33 |
| T₇ | 67.60 | 64.00 | 1152.67 |
| T₈ | 62.33 | 71.33 | 2212.33 |
| SEd | 6.7533 | 11.8695 | 437.4220 |
| CD (0.05) | 14.4860 | NS | 938.2788 |
| CD (0.01) | 20.1049 | NS | 1302.2275 |

Panicle length was highest in treatment T₇ (67.60) while treatment T₈ showed on par effect on panicle length. The treatment T₁ had the lowest value (42.67) of panicle length which was on par with T₃ (47.37), T₂ (49.90) and T₆ (50.27) for the same trait.

At initial stage, the treatment T₈ (control) registered more number of panicles/plant (71.33) and the treatment T₁ (43.67) registered less number of panicles/plant as shown in table 1.

### EXPERIMENT III

Effect of ‘Allwin Wonder’ on cane yield and sugar yield of sugarcane plants are shown in Table 5. The RDF used is in the ratio N 280: P2O5 62.5: K2O 100 Kg/ha.

Sugarcane is annual crop and consumes heavy fertilizer. The savings, treatment with Allwin Wonder and coating are shown below.

TABLE 5
EFFECT OF ‘ALLWIN WONDER’ ON CANE YIELD
AND SUGAR YIELD OF SUGARCANE PLANTS

| S. No | Treatment | Cane yield/Ha | Sugar yield/Ha |
|---|---|---|---|
| 1 | Clay soil (2010-2011) | 140.01 | 17.50 |
| | Allwin Wonder + | | |
| | 75% RDF | | |
| 2 | 100% RDF alone | 140.31 | 17.53 |
| 1 | Clay soil (2011-2012) | 121.58 | 17.82 |
| | Allwin Wonder + | | |
| | 75% RDF | | |
| 2 | 100% RDF alone | 119.75 | 17.68 |
| 1 | Sandy loam soil | 93.96 | 12.63 |
| | (2010-2011) | | |
| | Allwin Wonder + | | |
| | 75% RDF | | |
| 2 | 100% RDF alone | 91.2 | 11.74 |
| 1 | Sandy loam soil | 105.53 | 14.3 |
| | (2011-2012) | | |
| | Allwin Wonder + | | |
| | 75% RDF | | |
| 2 | 100% RDF alone | 102.6 | 14.02 |

From the above result, it is noted that in clay soil 75% RDF with ‘Allwin Wonder’ produced same result of 100% RDF whereas in sandy loam soil, 75% RDF with ‘Allwin Wonder’ has given higher yield than 100% RDF.

I claim:

1. A product to coat fertilizer in place of use comprising two or more of following constituents:
Facilitator;
Neutral acid slurry;
Bentonite clay; and
Resin,
wherein the product is mixed in place of use with conventional fertilizer.

2. The product to coat fertilizer as claimed in claim 1 utilized for one acre comprising of:
Facilitator: 1000 gm; and
Neutral acid slurry: 250 gm.

3. The product to coat fertilizer as claimed in claim 1 utilized for one acre comprising of:
(i) 1000 gm of facilitator; 1000 gm of Bentonite clay; and 250 gm of Resin; or
(ii) 1000 gm of facilitator; 1000 gm of Bentonite clay; and 500 gm of Resin,
wherein the resin is preferably vegetable oil resin.

4. The product as claimed in claim 1, wherein the facilitator is a starter heterocyclic compound comprising of Heterocyclic Nitrogen (N-18%) in amounts of 187 gms to 375 gms with Phosphorus (P-6%) and Potassium (K-9%) per acre.

5. A method of preparing the facilitator as claimed in claim 4 comprising the steps of:
Mixing Melamine (C3H6N6), HEDP (C2H8P2O7) and water thoroughly in a reaction tank to get homogenous slurry after heating at 50° C.;
Adding Potassium Hydroxide (KOH) to the homogenous slurry and mixing thoroughly;
Allowing the resultant mixture obtained to dry at moderate temperature in a mechanical drier;
Optionally, sieving to improve uniformity and remove dirt; and
Obtaining final product comprising Melamine Phosphate and Potash complex as a facilitator and starter.

6. A method of preparing the neutral acid slurry as claimed in claim 1 comprising the steps of:
Adding Sodium Hydroxide (NaOH) to acid Alkyl Benzene Sulfonate in a stainless steel vessel or heat resistant plastic vessel and mixing slowly till neutral pH is obtained; and
Obtaining black colored resultant slurry and further bleaching with urea in the ratio 1:10 kg slurry to obtain the neutral acid slurry.
